(19) United States
(12) Patent Application Publication
(10) Pub. No.: US 2010/0255748 A1
(43) Pub. Date: Oct. 7, 2010

(54) MANUFACTURING METHOD OF PLASMA DISPLAY PANEL

(76) Inventors: Seiji Imanaka, Osaka (JP); Shinichiro Ishino, Osaka (JP); Yuichiro Miyamae, Osaka (JP); Koyo Sakamoto, Osaka (JP); Yoshinao Ooe, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/744,539

(22) PCT Filed: Aug. 5, 2009
(86) PCT No.: PCT/JP2009/003732

§ 371 Date: May 25, 2010

(30) Foreign Application Priority Data
Aug. 20, 2008 (JP) 2008-211342

(51) Int. Cl. H01J 9/00

(52) U.S. Cl. 445/58

(57) ABSTRACT

The manufacturing method of the plasma display panel is a manufacturing method of a protective layer of a plasma display panel composed in which a base film is formed on a dielectric layer, and a plurality of crystal particles of metal oxide are distributed and bonded oh the base film uniformly on the entire surface, comprising an coating step of applying the crystal particles on the entire surface, in which the coating step includes a conveying step of descending when conveying by ascending is completed when conveying a plurality of front plates simultaneously, a positioning step of positioning by elevating when positioning the plurality of front plates simultaneously, and a printing step of printing a film of crystal particles at desired positions by fixing the plurality of front plates after positioning.

### TECHNICAL FIELD

The present invention relates to a manufacturing method of a plasma display panel to be used in a display device or the like.

### BACKGROUND ART

A plasma display panel (hereinafter called a PDP) is capable of realizing a high definition and a large screen, and is commercially produced as a 65-inch class television of the like. Recently, the PDP is advanced in application in high definition television of more than double number of scanning lines as compared with the conventional NTSC system.

Basically, the PDP is composed of a front plate and a rear plate. The front plate includes a glass substrate, a display electrode, a dielectric layer, and a protective layer. The glass substrate is made of sodium borosilicate glass by a float method. The display electrode is composed of a striped transparent electrode and a bus electrode formed on one principal surface of the glass substrate. The dielectric layer covers the display electrode, and functions as a capacitor. The protective layer is made of magnesium oxide (MgO) being formed on the dielectric layer. The rear plate includes a glass substrate, an address substrate, a base dielectric layer, a barrier rib, and a phosphor layer. The address layer is formed in stripes on one principal surface of the glass substrate. The base dielectric layer covers the address electrode. The barrier rib is formed on the base dielectric layer. The phosphor layer is formed between barrier ribs, and emits light in red color, green color, and blue color.

The front plate and the rear plate are hermetically sealed having the electrode forming sides formed oppositely to each other, and a discharge space closed by the barrier ribs is packed with Ne—Xe discharge gas at a pressure of 400 Torr to 600 Torr. The PDP discharges by selective application of a video signal voltage on the display electrode, and ultraviolet rays generated by this discharge excite each color phosphor layer to emit light in red color, green color, and blue color, thereby realizing a color image display. Such PDP is disclosed, for example, in patent document 1.

In such PDP, the role of the protective layer formed on the dielectric layer of the front plate is to protect the dielectric layer from ion impact by discharge, and to release initial electrons for generating an address discharge. Protection of the dielectric layer from ion impact is very important for preventing elevation of discharge voltage. Similarly, releasing of the initial electrons for generating an address discharge is very important for preventing address discharge error which may cause flickering of the image.

To increase the number of initial electrons discharged from the protective layer and to decrease flickering of the image, it has been attempted, for example, to add Si or Al to MgO.

Recently, the television is much advanced in high definition, and the market is demanding PDP products of low cost, low power consumption, and full high definition (HD) of high luminance (1920×1080 pixels: progressive display). The electron discharge characteristic from the protective layer determines the image quality of the PDP, and controlling of electron discharge characteristic is extremely important.

Moreover, in the PDP, it has been also attempted to improve the electron discharge characteristic by mixing impurities in the protective layer. However, if the electron discharge characteristic is improved by mixing impurities in the protective layer, an electric charge is accumulated on the protective layer surface at the same time, and the electric charge decreases along with the lapse of time when used as a memory function, and thereby the damping rate becomes higher. To suppress this trend, therefore, countermeasures are necessary, such as increase of the applied voltage. Thus, as the characteristic of the protective layer, it is required to satisfy two contradictory characteristics, that is, high electron releasing capacity, and small damping rate of electric charge as memory function, that is, high electric charge retaining characteristic.

### PRIOR ART LITERATURE

### Patent Document

Patent document 1: Japanese Patent Application Unexamined Publication No. 2003-128430

### SUMMARY OF THE INVENTION

The present invention is devised in the light of the problems in the conventional method, and it is hence a primary object thereof to present a manufacturing method of a PDP having a display performance of high definition and high luminance, and low power consumption.

The manufacturing method of a plasma display panel is a manufacturing method of a plasma display panel consisting of a front plate including a dielectric layer formed on a substrate so as to cover a display electrode, and a protective layer formed on the dielectric layer, and a rear plate including address electrodes disposed oppositely to form a discharge space on the front plate and in directions intersecting with the display electrode, and barrier ribs for dividing the discharge space, with the protective layer having a base film formed on the dielectric layer, and the base film having a plurality of crystal particles of metal oxide distributed on an entire surface, comprising an coating step of applying the crystal particles on the entire surface, in which the coating step includes a conveying step of descending when conveying by ascending is completed when conveying a plurality of front plates simultaneously, a positioning step of positioning by elevating when positioning the plurality of front plates simultaneously, and a printing step of printing a film of crystal particles at desired positions by fixing the plurality of front plates after positioning.

### BRIEF DESCRIPTION OF DRAWINGS

FIG. 1 is a perspective view of structure of a PDP in a preferred embodiment of the present invention.

FIG. 2 is a sectional view of structure of a front plate of the PDP in the preferred embodiment of the present invention.

FIG. 3 is a magnified view of a protective layer portion and others of the PDP in the preferred embodiment of the present invention.

FIG. 4 is a magnified view of agglomerated particles in the protective layer of the PDP in the preferred embodiment of the present invention.

FIG. 5 is a diagram showing forming steps of the protective layer in a manufacturing method of the PDP of the present invention.

FIG. 6 is a plan view and a side view of structure of a printing section in the present invention.

FIG. 7 is a plan view and a side view of positioning operation of the front plate in the present invention.

FIG. 8 is a plan view and a side view of fixing operation of the front plate in the present invention.

FIG. 9 is a side view of printing operation of the front plate in the present invention.

FIG. 10A is an explanatory diagram of delivering operation of the front plate in the present invention.

FIG. 10B is an explanatory diagram of delivering operation of the front plate in the present invention.

### PREFERRED EMBODIMENTS FOR CARRYING OUT THE INVENTION

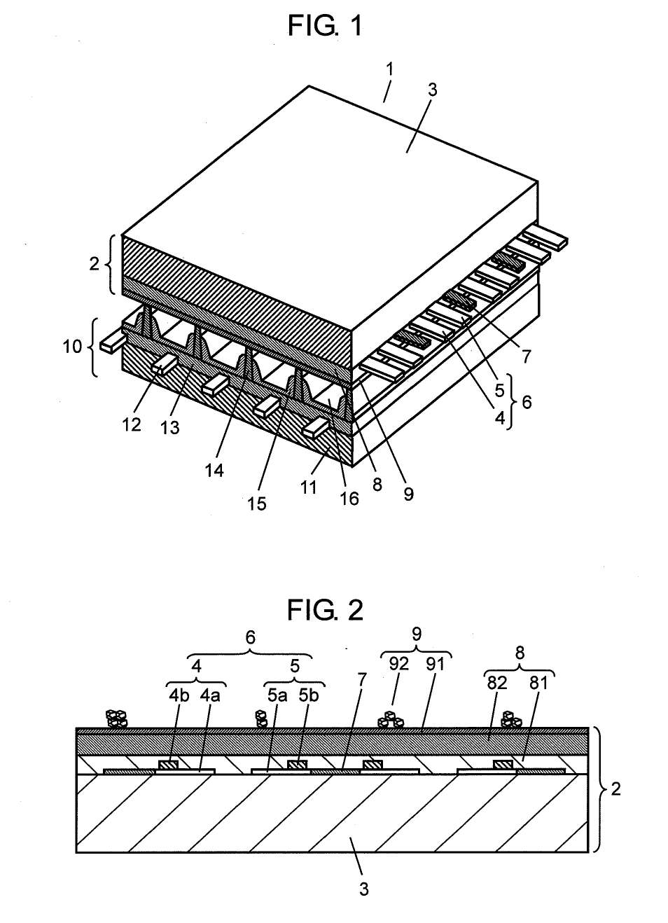

A PDP in a preferred embodiment of the present invention is described below while referring to the accompanying drawings. FIG. 1 is a perspective view of structure of a PDP in a preferred embodiment of the present invention. A basic structure of the PDP is same as that of a general AC surface discharge type PDP. As shown in FIG. 1, PDP 1 includes front plate 2 formed of front glass substrate 3 and others, and rear plate 10 formed of rear glass substrate 11 and others, disposed oppositely to each other, in which the outer circumference is hermetically sealed by a sealing member of glass frit or the like. Inside of the sealed PDP 1, discharge space 16 is packed with a discharge gas of Ne and Xe, at a pressure of 400 Torr to 600 Torr.

On front glass substrate 3 of front plate 2, a pair of band-like display electrodes 6 composed of scan electrodes 4 and sustain electrodes 5 and black stripes (light shielding layers) 7 are disposed in parallel to each other in a plurality of rows. On front glass substrate 3, dielectric layer 8 functioning as a capacitor is formed for covering display electrodes 6 and light shielding layers 7. Further on the surface, protective layer 9 composed of magnesium oxide (MgO) or the like is formed. Front glass substrate 3 is also called a substrate.

On rear glass substrate 11 of rear plate 10, a plurality of band-like address electrodes 12 are disposed in parallel to each other, in a direction orthogonal to scan electrodes 4 and sustain electrodes 5 of front plate 2, and they are covered with base dielectric layer 13. On base dielectric layer 13 between address electrodes 12, barrier ribs 14 of a specified height for dividing discharge space 16 are formed. In the grooves between barrier ribs 14, phosphor layers 15 for emitting light in red color, green color and blue color by ultraviolet ray are sequentially applied and formed in every one of address electrodes 12. Discharge cells are formed at intersecting positions of scan electrodes 4, sustain electrodes 5, and address electrodes 12, and the discharge cells having red, green and blue phosphor layers 15 arranged in a direction of display electrodes 6 become pixels for displaying a color image.

FIG. 2 is a sectional view of structure of front plate 2 of PDP 1 in a preferred embodiment of the present invention, and FIG. 2 is a view of FIG. 1 inverted upside down. Patterns of display electrodes 6 and light shielding layers 7 formed of scan electrodes 4 and sustain electrodes 5 are formed on front glass substrate 3 manufactured by flat method or the like as shown in FIG. 2. Scan electrodes 4 and sustain electrodes 5 are formed of transparent electrodes 4a, 5a made of indium tin oxide (ITO) or tin oxide (SnO2), and metal bus electrodes 4b, 5b formed on transparent electrodes 4a, 5a. Metal bus electrodes 4b, 5b are used for the purpose of providing with a conductivity in the longitudinal direction of transparent electrodes 4a, 5a, and are formed of a conductive material mainly composed of a silver (Ag) material.

Dielectric layer 8 is formed of at least two layers, that is, first dielectric layer 81 formed on front glass substrate 3 to cover transparent electrodes 4a, 5a, metal bus electrodes 4b, 5b, and light shielding layers 7, and second dielectric layers 82 formed on first dielectric layer 81. Protective layer 9 is formed on second dielectric layer 82.

The manufacturing method of the PDP is explained below. On front glass substrate 3, scan electrodes 4, sustain electrodes 5, and light shielding layers 7 are formed. These transparent electrodes 4a, 5a and metal bus electrodes 4b, 5b are patterned and formed by a photolithography method or other. Transparent electrodes 4a, 5a formed by thin film process or other method, and metal bus electrodes 4b, 5b are solidified by firing a paste containing a silver (Ag) material at specified temperature. Light shielding layers 7 are similarly formed by firing after screen printing of a paste containing a black pigment, or patterning and firing by photolithography method after forming the black pigment on the entire surface of the glass substrate.

Next, to cover scan electrodes 4, sustain electrodes 5, and light shielding layers 7, a dielectric paste is applied on front glass substrate 3 by die-coating or other method, and a dielectric paste layer (dielectric material layer) is formed. After application of the dielectric paste, by letting stand for a specified time, the applied dielectric paste surface is leveled to become a flat surface. Afterwards, by firing and solidifying the dielectric paste layer, dielectric layer 8 covering scan electrodes 4, sustain electrodes 5, and light shielding layers 7 is formed. The dielectric paste is a paint material containing glass powder or other dielectric material, binder, and solvent. On dielectric layer 8, protective layer 9 made of magnesium oxide (MgO) is formed by vacuum deposition method. By these steps, a specified composition (scan electrodes 4, sustain electrodes 5, light shielding layers 7, dielectric layer 8, and protective layer 9) is formed on front glass substrate 3, and thereby front plate 2 is completed.

On the other hand, rear plate 10 is manufactured as follows. First, on rear glass substrate 11, a material layer is formed as a composition for address electrodes 12, by a screen printing method of a paste containing a silver (Ag) material, or a patterning method by photolithography method after forming a metal film on the entire surface. The formed material layer is fired at a specified temperature, and address electrodes 12 are formed. Further, on rear glass substrate 11 on which address electrodes 12 are formed, a dielectric paste is applied so as to cover address electrodes 12 by die-coating or other method, and a dielectric paste layer is formed. Consequently, by firing the dielectric paste layer, base dielectric layer 13 is formed. The dielectric paste is a paint material containing glass powder or other dielectric material, and a binder and a solvent.

Next, a barrier rib forming paste containing a barrier rib material is applied on base dielectric layer 13, and patterned in a specified shape, and a barrier rib material is formed, and fired, and barrier ribs 14 are formed. Herein, the method of patterning a barrier rib forming paste applied on base dielectric layer 13 includes a photolithography method and a sand-blasting method. Further, a phosphor paste containing a phosphor material is applied on base dielectric layer 13 between adjacent barrier ribs 14 and on the side surface of barrier ribs 14, and fired, and a phosphor layer 15 is formed. After these steps, rear plate 10 having a specified composition material is formed on rear glass substrate 11.

In this manner, front plate 2 and rear plate 10 having specified composition materials are disposed oppositely to each other so that scan electrodes 4 and address electrodes 12 are orthogonal to each other, and the circumference is sealed with glass frit, and discharge space 16 is packed with discharge gas containing Ne and Xe, and thereby PDP 1 is completed.

Herein, the composition of the protective layer of the PDP of the present invention and its manufacturing method are explained.

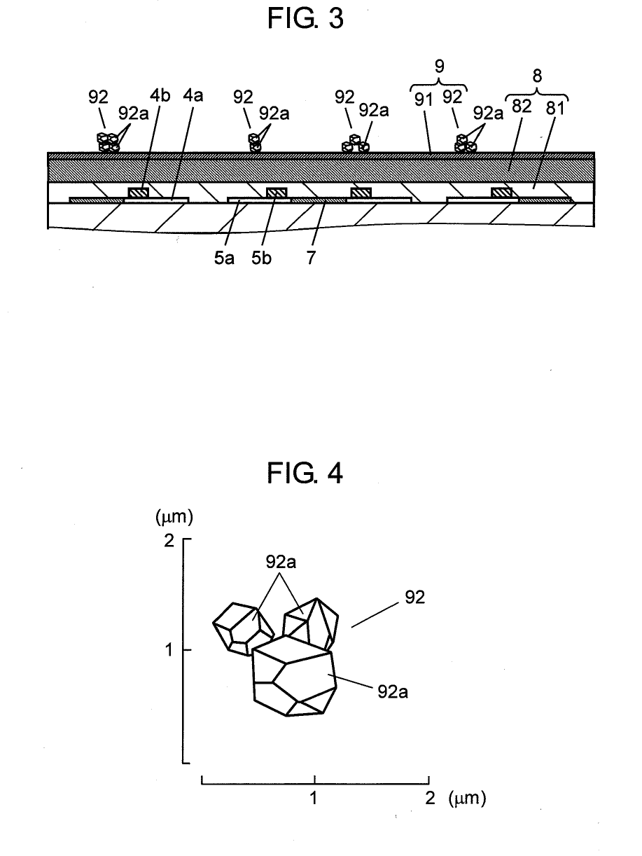

FIG. 3 is a magnified view of a protective layer portion and others of the PDP of the present invention. In the PDP of the present invention, as shown in FIG. 3, protective layer 9 has base film 91 formed on dielectric layer 8, agglomerated particles 92 are scattered discretely distributed and bonded almost uniformly on the entire surface of base film 91. Base film 91 is composed of MgO containing Al as impurities. Agglomerated particles 92 are formed by aggregating a plurality of crystal particles 92a of metal oxide MgO.

FIG. 4 is a magnified view explaining agglomerated particles 92 in protective layer 9 of the PDP of the present invention. Agglomerated particles 92 are formed as an aggregating or necking group of crystal particles 92a of a specified primary particle size as shown in FIG. 4. Not a bonded body having a large binding force as a solid body, a plurality of primary particles are gathered as a group by static electricity or van der Waals force, being bonded to such a degree to become primary particles in part or in whole, by external stimulation by ultrasonic waves or the like. The particle size of agglomerated particles 92 is about 1 μm, and crystal particles 92a are preferred to be polyhedral shapes having 14 facets, 12 facets, or 7 or more facets.

The particle size of primary particles of crystal particles 92a of the MgO can be controlled by the forming condition of crystal particles 92a. For example, when forming by firing a precursor of MgO of magnesium carbonate or magnesium hydroxide, the particle size can be controlled by controlling the firing temperature or firing atmosphere. Generally, the firing temperature may be selected in a range of about 700 degrees to about 1500 degrees, and by setting the firing temperature at a relatively high temperature, for example, more than 1000 degrees, the primary particles diameter can be controlled to about 0.3 to 2 μm. Further, by obtaining crystal particles 92a by heating the MgO precursor, in the forming process, a plurality of primary particles are bonded by a phenomenon called aggregation or necking, and agglomerated particles 92 can be obtained.

Agglomerated particles 92 having a specified particle size distribution obtained in this process are mixed together with resin components and a solvent, and an agglomerated particle paste is prepared, which is printed on base film 91 of protective layer 9.

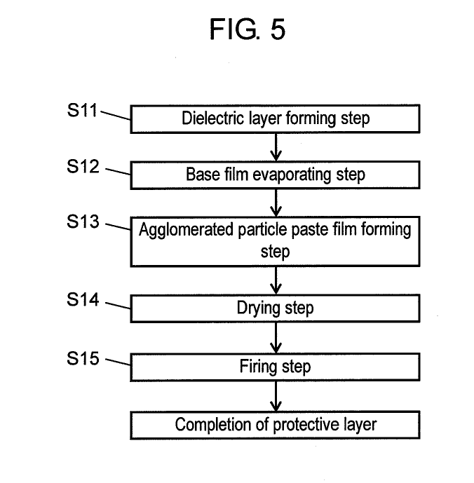

The manufacturing steps of forming the protective layer of the PDP of the present invention are described below while referring to FIG. 5.

FIG. 5 shows the forming steps of the protective layer in the manufacturing method of the PDP of the present invention. As shown in FIG. 5, dielectric layer 8 of a laminated structure of first dielectric layer 81 and second dielectric layer 82 is formed in dielectric layer forming step S11. Next, in base film evaporating step S12, by vacuum deposition method, a base film of MgO composed of a sinter of MgO containing Al as raw material is formed on second dielectric layer 82 of dielectric layer 8.

Further, a plurality of agglomerated particles is discretely bonded on an unfired base film formed in base film evaporating step S12.

In succession, a step of bonding agglomerated particles, first, agglomerated particle paste film forming step S13 is executed. In this agglomerated particle paste film forming step S13, an example of forming a plurality of (two in this case) front plates simultaneously is explained.

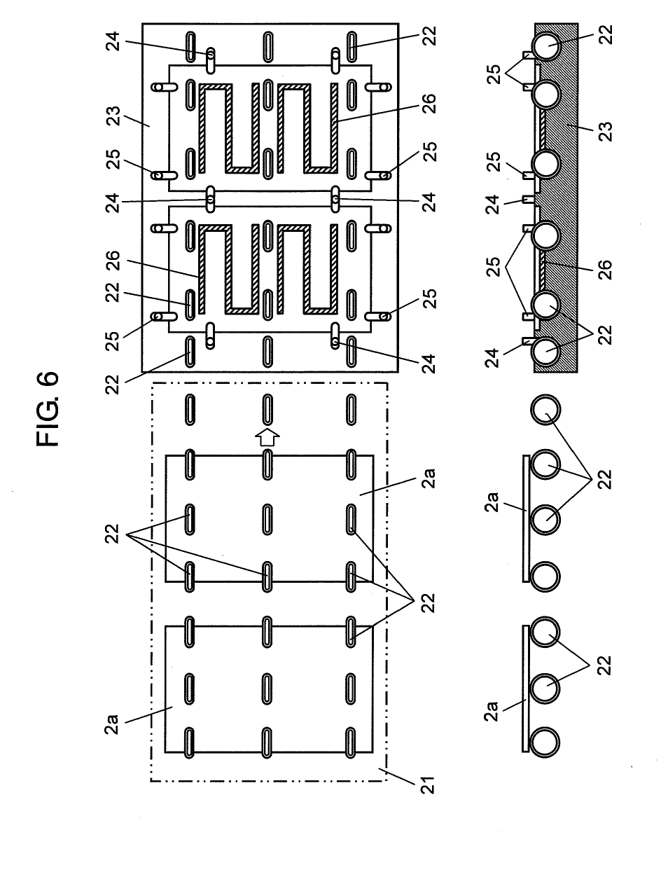

FIG. 6 is a plan view and a side view showing a configuration of the printing portion in the present invention. In FIG. 6, the upper side diagram is a plan view, and the lower side diagram is a side view. First, as shown in FIG. 6, two unfired front plates 2a after forming of base film are simultaneously conveyed in a longitudinal direction and an orthogonal direction from the arrow direction in the drawing, at a specified interval, so that the longer sides may be parallel to each other, up to printing stage 23 by conveying roller 22 of conveying conveyor 21.

On printing stage 23, conveying rollers 22 disposed on this printing stage 23 have a mechanism of moving up and down. When unfired front plates 2a are conveyed, conveying rollers 22 project to the upper side of printing stage 23, so that unfired front plates 2a moved on printing stage 23. Positioning pins 24, 25 are positioning pins intended to determine the position of unfired front plates 2a moved onto printing stage 23. Vacuum groove 26 is provided on printing stage 23. By sucking through this vacuum groove 26, unfired front plates 2a are sucked and attracted to printing stage 23.

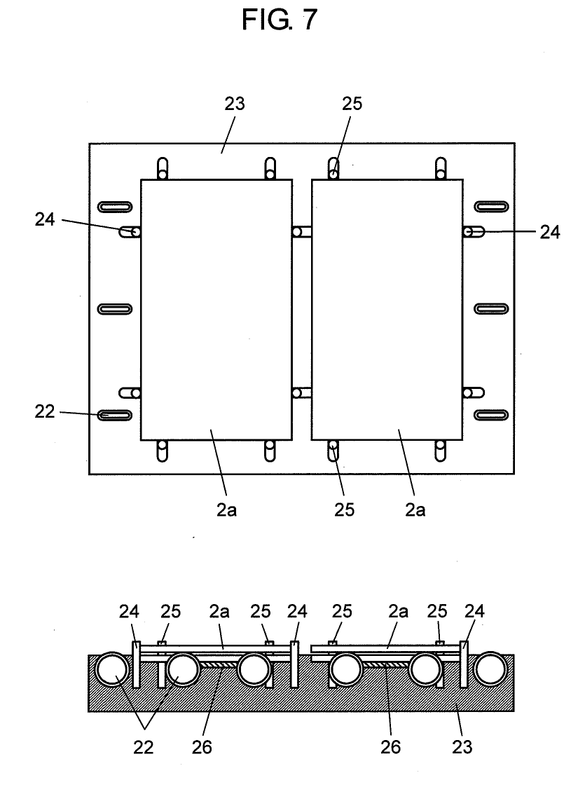

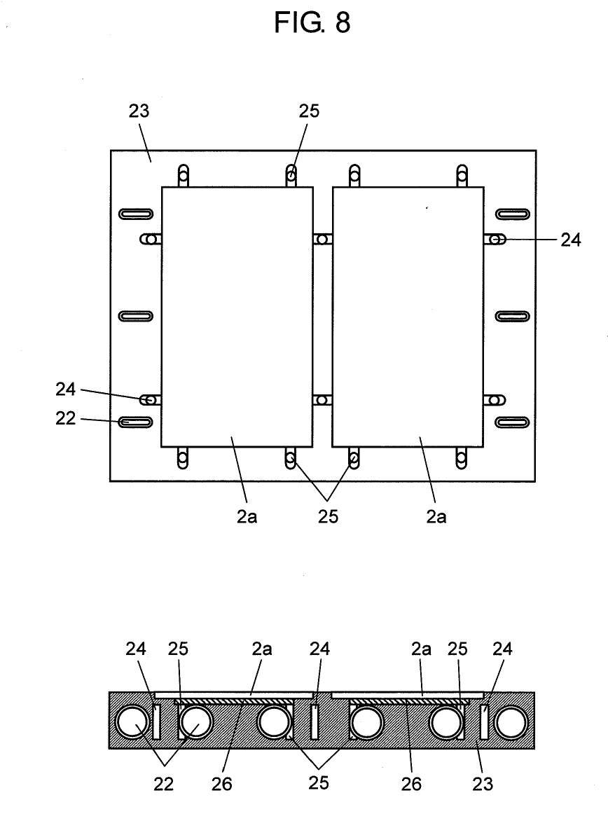

FIG. 7 is a plan view and a side view showing the positioning operation of the front plates in the present invention. FIG. 8 is a plan view and a side view showing the fixing operation of the front plates in the present invention. In FIG. 7 and FIG. 8, the upper side diagram is a plan view, and the lower side diagram is a side view. Unfired front plates 2a moved onto printing stage 23 are positioned, as shown in FIG. 7, in the lateral direction by means of positioning pins 25, and are positioned in the longitudinal direction by positioning pins 24 while being positioned in the lateral direction. While maintaining this state, as shown in FIG. 8, positioning pins 24, 25 are departed from unfired front plates 2a, and are lowered beneath printing stage 23. Afterwards, conveying rollers 22 descend beneath printing stage 23, and unfired front plates 2a are mounted on printing stage 23. By evacuating vacuum groove 26 provided in printing stage 23, unfired front plates 2a are sucked and fixed to printing stage 23.

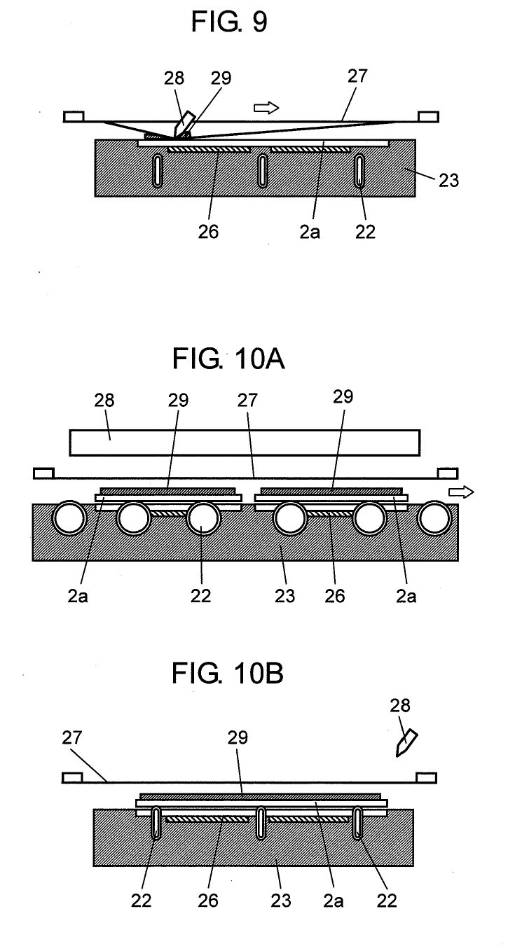

FIG. 9 is a side view showing the printing operation of the front plates in the present invention. As shown in FIG. 9, screen plate 27 descends on unfired front plates 2a fixed by vacuum groove 26, and squeegee 28 of the printing unit is moved in the arrow direction, so that agglomerated particle paste 29 is printed. In this printing process, since squeegee 28 is always contacting with unfired front plates 2a, agglomerated particle paste 29 of crystal particles of MgO may be uniformly printed in a desired area.

FIG. 10A and FIG. 10B are explanatory diagrams showing the delivering operation of the front plates in the present invention. As shown in FIG. 10A and FIG. 10B, after a film of agglomerated particle paste 29 is formed on unfired front plates 2a, the printing unit ascends, and also screen plate 27 ascends. When ascending of printing unit, screen plate 27 are complete, the vacuum of printing stage 23 is released, and the suction force of printing stage 23 is lost, and in this state, conveying rollers 22 positioned beneath printing stage 23 begin to ascend. After the film of agglomerated particle paste 29 is formed, unfired front plates 2a are lifted from printing stage 23, and are conveyed into the arrow direction in FIG. 10A by conveying rollers 22.

Conveyed unfired front plates 2a are sent to next drying step S14, and dried. Afterwards, the unfired base film formed in base film evaporating step S12, and the agglomerated particle paste film formed in agglomerated particle paste film forming step S13 and dried in drying step S14 are fired simultaneously in firing step S15 for heating and firing at a temperature of several hundred degrees. As a result, the solvent and resin components left over in the agglomerated particle paste film are removed, thereby forming protective layer 9 having a plurality of agglomerated particles 92 bonded on base film 91.

According to this method, a plurality of agglomerated particles 92 can be uniformly distributed and bonded on base film 91 of two unfired front plates 2a coated with protective base films.

In the above explanation, an example of two unfired front plates coated with protective base films is explained, but same effects are obtained if three or more panels are arranged in parallel and printed simultaneously at the longitudinal side.

In the above explanation, moreover, MgO is used as the protective layer, but any other material may be used as far as conforming to the required performance of base film 91, that is, a high resistance to spattering to protect the dielectric material from ion impact, and any particular high charge retaining capacity or high electron releasing performance is not needed. In the conventional PDP, in order to satisfy the two contradictory conditions of relatively high electron releasing performance and spattering resistance, the protective layer is mainly composed of MgO. But because of the composition of controlling the electron releasing performance dominantly by single crystal particles of metal oxide, MgO is not particularly required, and any other material excellent in impact resistance such as Al₂O₃ or the like may be used.

In the preferred embodiment of the present invention, MgO particles are used as single crystal particles, but other single crystal particles may be used. For example, same effects may be obtained by using other crystal particles by oxide of metal such as Sr, Ca, Ba, or Al having a high electron releasing performance same as MgO, and crystal particles are not limited to MgO.

As clear from the explanation herein, the present invention provides a manufacturing method of a PDP having a display performance of low power consumption, high definition and high luminance, by presenting a PDP capable of improving the electron releasing characteristic, having a charge retaining characteristic, and satisfying high picture quality, low cost, and low voltage.

### INDUSTRIAL APPLICABILITY

As described herein, the present invention is very useful as a manufacturing method of a PDP having a display performance of high definition and high luminance, and low in power consumption.

### DESCRIPTION OF REFERENCE MARKS

1 PDP
2 Front plate
2a Unfired front plate
3 Front glass substrate
4 Scan electrode
4a, 5a Transparent electrode
4b, 5b Metal bus electrode
5 Sustain electrode
6 Display electrode
7 Black stripe (light shielding layer)
8 Dielectric layer
9 Protective layer
10 Rear plate
11 Rear glass substrate
12 Address electrode
13 Base dielectric layer
14 Barrier rib
15 Phosphor layer
16 Discharge space
21 Conveying conveyor
22 Conveyer roller
23 Printing stage
24, 25 Positioning pin
26 Vacuum groove
27 Screen plate
28 Squeegee
29 Agglomerated particle paste
81 First dielectric layer
82 Second dielectric layer
91 Base film
92 Agglomerated particle
92a Crystal particle

1. A manufacturing method of a plasma display panel,
the plasma display panel including:
a front plate including a dielectric layer formed on a substrate so as to cover a display electrode; and a protective layer formed on the dielectric layer;
a rear plate including address electrodes disposed oppositely to form a discharge space on the front plate and in directions intersecting with the display electrode, and barrier ribs for dividing the discharge space; and
the protective layer having a base film formed on the dielectric layer, and the base film having a plurality of crystal particles of metal oxide distributed on an entire surface,
the manufacturing method comprising:
a coating step of applying the crystal particles on the entire surface,
wherein the coating step includes:
a conveying step of descending when conveying by ascending is completed when conveying a plurality of front plates simultaneously;
a positioning step of positioning by elevating when positioning the plurality of front plates simultaneously; and
a printing step of printing a film of crystal particles at predetermined positions by fixing the plurality of front plates after positioning.
